(19) United States
(12) Patent Application Publication
(10) Pub. No.: US 2026/0136411 A1
(43) Pub. Date: May 14, 2026

(54) IMPROVED START SIGNAL PROCEDURES FOR RADIO TAGS

(71) Applicant: Fraunhofer-Gesellschaft zur Foerderung der angewandten Forschung e.V., Munich (DE)

(72) Inventors: Thomas FEHRENBACH, Berlin (DE); Baris GÖKTEPE, Berlin (DE); Thomas WIRTH, Berlin (DE); Thomas SCHIERL, Berlin (DE); Cornelius HELLGE, Berlin (DE); Thomas WIEGAND, Berlin (DE); Alvaro LÓPEZ RAVENTÓS, Berlin (DE); Buket TORUN, Berlin (DE)

(21) Appl. No.: 19/382,592

(22) Filed: Nov. 7, 2025

(30) Foreign Application Priority Data
Nov. 8, 2024 (EP) 24211935.2

(51) Int. Cl. H04W 76/14; H04L 5/00; H04W 4/80; H04W 8/00; H04W 76/15

(52) U.S. Cl. CPC H04W 76/14; H04L 5/0007; H04W 8/005; H04W 76/15; H04W 4/80

(57) ABSTRACT

A radio transmitter apparatus for transmitting a data transmission for at least one radio tag of a plurality of radio tags is described. The data transmission includes a first part and a second part including data to be transmitted to the at least one radio tag. The radio transmitter apparatus processes the second part of the data transmission such that the data is free of a pattern representing a start indicator for any of the plurality of radio tags.

### CROSS-REFERENCES TO RELATED APPLICATIONS

This application claims priority from European Patent Application No. EP 24 211 935.2, which was filed on Nov. 8, 2024, and is incorporated herein in its entirety by reference.

The present invention relates to the field of radio tags and reader devices for wireless communication systems or networks, more specifically to low complexity radio tags employing low-power communication techniques. Embodiments of the present invention concern enhancements of start signal procedures for low complexity radio devices or radio tags.

Low complexity radio devices or radio tags using backscattered communication techniques for transmitting a signal are well-known, see, e.g., Jin-Ping Niu, Geoffrey Ye Li in “An Overview on Backscatter Communications”, Journal of Communications and Information Networks, Vol. 4, No. 2, June 2019. One example of low complexity radio devices using backscatter communication techniques are radio frequency identification, RFID, tags. An RFID tag identification is performed through a series of interactions between an RFID reader and an RFID tag. Radio frequency signals are used to communicate and exchange data between the RFID reader and the RFID tag. An RFID tag, which has a unique identification, ID, responds to a query of an RFID reader by transmitting information stored in the RFID tag. This process, also known as inventorying, uses anti-collision algorithms, like the slotted ALOHA protocol, to manage multiple tags within a RFID reader's field or communication range and for avoiding signal interferences. The RFID tags are typically identified individually, with the RFID reader sequentially querying each RFID tag to compile a list of all RFID tags within the RFID reader's communication range. The actual identification process varies dependent on the type of RFID tags in use, which may be passive, semi-passive or active. Passive RFID tags, which are most common due to their cost-effectiveness, rely entirely on the RFID reader's signal for power. These RFID tags backscatter the received signal to transmit data stored in the RFID tag. Semi-passive RFID tags have an internal battery to power the circuits of the RFID tag thereby improving the read range and the data transmission reliability. Active RFID tags, which are equipped with an own power source, may communicate over greater distances and may store more data, making them suitable for applications requiring more coverage.

Another technology using low complexity devices using backscatter communication techniques for low power consumption involve Internet-of-Thing, IoT, devices in accordance with the 3GPP standard. Such IoT devices are currently further developed so as to provide ultra-low complexity devices with ultra-low power consumption, especially for very low end IoT applications. Such further developed IoT devices, like Ambient IoT devices, are well-below the existing 3GPP technologies, e.g., narrowband IoT (NB-IoT) devices, enhanced Machine Type Communication (eMTC) devices, or devices with reduce capabilities (RedCap devices). The further development of IoT devices towards ultra-low complexity devices with ultra-low power consumption is not driven by a desire to replace existing low-power wide area, LPWA, systems, rather, it is driven by the desire to provide a missing piece of ultra-low complexity and ultra-low power devices in the 3GPP system such that other 3GPP devices, like a user equipment or user device, UE, a base station, BS, or any New Generation Radio Access Network (NG-RAN) node may directly or indirectly connect with such devices or may be used for controlling or managing a whole system including thousands of low complexity devices like Ambient IoT devices. The ultra-low complexity IoT devices having ultra-low power consumption may be classified in the following power classes:
(1) The device has a peak power consumption of about 1 μW and includes an energy storage. The device has an initial sampling frequency offset, SFO, of up to 10^{x} ppm. The device provides neither a downlink, DL, amplification nor an uplink, UL, amplification. An uplink transmission of the device is backscattered on a carrier wave provided by an external source.
(2) The device has a peak power consumption less than a few hundred μW and includes an energy storage. The device has an initial sampling frequency offset, SFO, of up to 10^{x} ppm. The device provides a downlink, DL, amplification and/or an uplink, UL, amplification. An UL transmission may be generated internally by the device or may be backscattered on a carrier wave provided by an external source.

A maximum communication distance of such devices, when being deployed indoors, is between 10 m and 50 m. Different topologies are supported, e.g., topology 1 and/or topology 2. In detail, topology 1 refers to a direct communication between the reader and the device, while topology 2 involves the use of an intermediate node. In the latter, a user equipment, UE, may be provided in such topologies as an intermediate note which is under control of the 3GPP network for supporting the IoT devices with low complexity and low power consumption which may have no Radio Resource Control, RRC, states, provide for no mobility support, i.e., do not support any cell selection and/or cell reselection functions, and do not have any feedback capabilities, like hybrid acknowledge request, HHARQ, and/or acknowledge request, ARQ, capabilities.

Like in RFID systems, also in the above-described IoT systems, each IoT device is assigned with a unique identifier, ID, and/or a group-ID for allowing the identification and tracking of a single IoT device or of a set of IoT devices.

The above-described RFID systems and IoT systems focus on an individual tag identification using, for example, a unique identifier or individual tag identification, which may be used for single devices or for a group of devices. However, such systems are not capable to handle scenarios in which the devices belong to different groups simultaneously.

For instance, a supply chain item may belong to multiple groups depending on different aspects, like product type (e.g., fragile, electronic, perishable), storage requirements (e.g., refrigerated, climate-controlled), and shipment details (e.g., batch number, shipping method). In such a context, conventional RFID/IoT systems which support single tag/single group operations, lack mechanisms for managing overlapping group memberships. Such limitations hinder an efficient management and tracking across multiple functional categories leading to multiple constraints. For example, the rigid structure of single group-ID indications reduces the system flexibility and makes it difficult to adapt to changing environments where items or individuals frequently shift between different groups. Also the lacking capacity to manage overlapping groups makes resource allocation and tracking cumbersome and difficult and leads to undesired delays.

Further, conventional systems do not inherently support the requirements for a group reconfiguration responsive to changing operational needs which, in turn, restricts the ability of conventional systems to adapt to real-time conditions, such as fluctuating inventory levels, varying environment conditions or shifting operational properties. Also the lack of mechanisms for managing group-specific commands and responses increases a complexity in applications that require dynamic grouping.

In conventional radio tag systems, like ambient-IoT systems or RFID systems, a start signal is provided for indicating the beginning of a transmission intended for a radio tag. This start signal is also referred to as a wake-up signal or as a start indicator or as a start indicator pattern. For example, a data transmission may include a first part and at lease a second past. The first part may include the start indicator for the intended radio tag, and the second part includes the data, like payload data or control data, that is to be transmitted to the intended radio tag. For correctly addressing the respective radio tags, the start signal or wake-up signal may be unique for each radio tag. The second part of a data transmission may include a pattern, like a bit pattern, that corresponds to a unique start signal or wake-up signal of a certain radio tag, which is not the indented receiver of a data transmission. This causes the certain radio tag to erroneously wake up from an energy saving mode and prepare for a communication with a reader device for receiving data from the reader device. With a low number of transmissions in the system, the likelihood of a second part of a transmission actually including a unique start signal pattern is low, however, given the ever increasing amount of data to be handled within radio tag systems, also the number of data transmissions increase and with the increased number of data transmissions also the likelihood or a probability increases that a certain pattern appears within the second part of the data transmission, that may also be referred to herein as the data portion data signal. As a consequence also the number of radio tags that is erroneously falsely activated increases This false detection of a new start signal may cause a loss of synchronization due to the radio tag resetting its circuitry thereby interrupting any ongoing data reception. Also a data corruption may occur as parts of the actual data may be misinterpreted or lost. Further, the wake-up of the radio tag due to the false detection of a new start signal results in an increased power consumption which is especially critical for ultra-low power devices. Thus, the effect of a patterns in the data portion of a data transmission that correspond to a unique start signal of a certain radio tag is no longer negligible.

It is noted that the information in the above section is only for enhancing the understanding of the background of the present invention and, therefore, it may contain information that does not form conventional technology that is already known to a person of ordinary skill in the art.

Starting from the above, there may a need for enhancing start signal procedures for low complexity radio tags or devices, for example for RFID tags or for low complexity IoT devices.

Embodiments of the present invention address the above described problems in conventional radio tag systems by avoiding data transmissions having a data portion including a unique start signal or wake-up signal for a radio tag.

Although existing communication systems may employ certain techniques for addressing similar issues, such conventional approaches are not feasible for radio tag devices due certain constraints or restrictions to which radio tags are subject. The existing techniques may use bit stuffing, for example when employing the high-level data link control, HDLC, network protocol. In accordance with such an approach, extra bits are inserted into a bit stream when specific patterns are detected to prevent a confusion with control signals. However, the additional bits become part of the actual data to be decoded at a receiver and, therefore additional processing may be required at the received when compared to processing a unmodified data transmission. Given the low complexity of a radio tag such additional processing may not be feasible for the radio tag. Another technique is to apply byte stuffing, for example, when operating on the basis of a point-to-point protocol, PPP. In accordance with this technique, special characters, namely escape bytes, are used for differentiating data from control characters. Again, the data is altered requiring additional processing at the receiver. Yet other techniques employ certain coding schemes, e.g., 8b/10b encoding, for mapping data bytes to codewords in a way that certain patterns are avoided. The processing of different coding schemes at the receiver also goes together with an additional processing. Thus, such conventional techniques are not feasible for radio tags given their constraints or restrictions regarding, e.g., data processing capabilities which may not be suited for the increased data size obtained by bit stuffing and byte stuffing. The bit stuffing and the byte stuffing thus adds overhead and increases the amount of data transmitted. Also, the conventional techniques lead to a higher complexity for handling the data transmission. For example, employing enhanced encoding schemes requires more processing power and more memory. Also, the additional computation and transmission time required for the conventional techniques consumes additional energy which is scarce for ultra-low-power devices, like radio tags.

In accordance with the present invention, a mechanism is provided which does not impose significant computation or power overhead on the radio tags but ensures that a start indicator pattern does not unintentionally appear within the data portion or second part of a data transmission, i.e., within the payload data or control data, thereby avoiding at a radio tag a false detection of a new start signal and thereby avoiding a resulting loss of synchronization or a data corruption or an increase in the power consumption.

Embodiments of the present invention may be implemented in a wireless communication system including RAN entities, like base stations, reader devices, like UEs or mobile terminals, and radio tags, like A-IoT devices or RFID tags. FIG. 1 is a schematic representation of a wireless communication system including a plurality of radio tags 100a, 100b and one or more reader devices 200, like a UE or a RAN entity, e.g., a base station. The radio tags 100a, 100b and the reader device 200 may communicate via respective wireless communication links or channels 300a, 300b. The radio tags 100a, 100b may include one or more antennas ANT_{Tag} or an antenna array having a plurality of antenna elements, a signal processor or chip 102a, 102b and a transceiver 104a, 1040b, coupled with each other. The reader device 200 includes one or more antennas ANT_{R} or an antenna array having a plurality of antennas, a signal processor 202, and a transceiver 202 coupled with each other. The system or network of FIG. 1, the one or more radio tags 100a, 100b of FIG. 1, and the one or more reader devices 200 of FIG. 1 may operate in accordance with the inventive teachings described herein.

### SUMMARY

An embodiment may have a radio transmitter apparatus for transmitting a data transmission for at least one radio tag of a plurality of radio tags, wherein the data transmission comprises a first part and a second part including data to be transmitted to the at least one radio tag, and the radio transmitter apparatus is to process the second part of the data transmission such that the data is free of a pattern representing a start indicator for any of the plurality of radio tags.

Another embodiment may have a radio tag for receiving from a radio transmitter apparatus, which serves a plurality of radio tags, a data transmission, wherein the data transmission comprises a first part and a second part including data to be transmitted to the at least one radio tag, and the radio tag is to process the second part of the data transmission received from the radio transmitter apparatus for acquiring from the received data transmission payload data and/or control data for the radio tag.

Another embodiment may have a method for operating a radio transmitter apparatus for transmitting a data transmission for at least one radio tag of a plurality of radio tags, wherein the data transmission comprises a first part and a second part including data to be transmitted to the at least one radio tag, the method comprising: processing the second part of the data transmission such that the data is free of a pattern representing a start indicator for any of the plurality of radio tags.

The present invention provides a radio transmitter apparatus for transmitting a data transmission for at least one radio tag of a plurality of radio tags, wherein the data transmission comprises a first part and a second part including data to be transmitted to the at least one radio tag, and the radio transmitter apparatus is to process the second part of the data transmission such that the data is free of a pattern representing a start indicator for any of the plurality of radio tags.

In accordance with embodiments, the first part includes a start indicator, e.g., start indicator of the at least one radio tag.

In accordance with embodiments, the first part contains control signaling associated with the second part of the data transmission.

In accordance with embodiments, the start indicator causes one or more radio tags, or a group of radio tags to be activated for a communication.

In accordance with embodiments, the at least one radio tag is an Ambient IoT (A-IoT) device, and wherein the data transmission comprises an A-IoT Reader-to-Device (R2D) signal divided into two parts, the first part including an R2D Timing Acquisition Signal (R-TAS), which includes a Start Indication Pattern (SIP) and a Clock Acquisition Part (CAP), and the second part including a physical reader-to-device channel (PRDCH) and a postamble.

In accordance with embodiments, the SIP provides a recognizable sequence that enables the A-IoT device to differentiate the A-IoT Reader-to-Device (R2D) signal from noise or other transmissions, and wherein the CAP provides additional control signaling and clock synchronization for an accurate decoding of the subsequent PRDCH.

In accordance with embodiments, the CAP of the R-TAS encodes a chip rate of a remainder of the transmission, e.g., a number of chips per OFDM symbol

$$( {M}_{chip}^{symb} ) ,$$

In accordance with embodiments, a value of

$${M}_{chip}^{symb}$$

according to which the CAP is received is determined from among those given in the following table:

| Number of chips per OFDM | |
|---|---|
| $symbol ( {M}_{chip}^{symb} )$ | ${N}_{R B}^{min}$ |
| 2 | 1 |
| 6 | 1 |
| 12 | 2 |
| 24 | 3 |

In accordance with embodiments, a PRDCH transmission begins in chip

$$χ = {χ}_{start}^{PRDCH} ,$$

where:

$${χ}_{start}^{PRDCH} = {N}_{SIP} + {N}_{CAP} ,$$

an R2D transport block size is

$${N}_{TBS}^{R 2 D} .$$

In accordance with embodiments, the start indicator comprises one or more of the following:
a preamble,
one or more pilot symbols, e.g., a configured or preconfigured pattern of symbols,
a Zadoff-Chu sequence.

In accordance with embodiments, the start indicator comprises the start indicator part (SIP) of the R2D timing acquisition signal (R-TAS) which consists of N_{SIP}=8 bits denoted S₀, S₁, S₂, S₃, S₄, S₅, S₆, S₇=1, 1, 0, 0, 1, 0, 0, 0.

In accordance with embodiments, wherein the radio transmitter apparatus is to process the second part of the data transmission before transmitting the data transmission for the at least one radio tag using one or more of the following:
data scrambling,
data interleaving,
bit insertion,
bit extraction or deletion,
Cyclic Redundancy Check, CRC, adaption.

In accordance with embodiments, the radio transmitter apparatus is to insert one or more bits or chips at one or more certain positions in the second part of the data transmission, e.g., such that any start indicator pattern in the data is interrupted.

In accordance with embodiments, the radio transmitter apparatus processes the second part of the A-IoT Reader-to-Device (R2D) signal using padding chips that are set to any values which do not result in another R-TAS SIP.

In accordance with embodiments, for an R2D transmission the mapping to chips is as follows:
to chips χ=0 and up are mapped:
   the bits of the R-TAS SIP in sequence starting with S₀ followed by
   the bits of the R-TAS CAP in sequence starting with A₀ followed by
   the bits of PRDCH in sequence starting with c₀ followed by
   the bits of the R2D postamble in sequence starting with P₀.

In accordance with embodiments, if

$${M}_{chip}^{symb} = 24 ,$$

chips χ=χ′, χ′+1 satisfying (χ′−N_{SIP}) modulo

$${M}_{chip}^{symb} = {M}_{chip}^{symb} - 2$$

are skipped for the mapping of PRDCH and the R2D postamble, and are instead set to values of 1.

In accordance with embodiments, following postamble bit P₃, the smallest integer N_{pad}≥0 padding chips are inserted, if needed,

$$until ( {M}_{chip}^{R 2 D} - {N}_{SIP} ) modulo {M}_{chip}^{symb} = 0 ,$$

with the padding chips set to any values which do not result in another R-TAS SIP, and wherein, if

$${M}_{chip}^{symb} = 24 ,$$

values or 1 are mapped to the final two padding chips.

In accordance with embodiments, the first part contains a data channel, which may or may not be associated with the second part of the data transmission.

In accordance with embodiments, the first and/or second part of the data transmission comprises one of more of the following:
a transmission of data, like payload data and/or control data,
a retransmission of data, like payload data and/or control data, e.g., a transmission of previously transmitted data,
a redundancy transmission of data, like payload data and/or control data, e.g., a transmission of an exact copy of the data or a redundancy version of the data, e.g., previously transmitted data and/or data stored in a data buffer of the radio transmitter apparatus
a control signaling,
downlink control information, DCI,
a downlink and/or uplink grant,
sidelink control information, SCI,
HARQ feedback information,
random access, RA, information.

In accordance with embodiments, the radio transmitter apparatus is to process the data so as to create a data start indication for the first part of the data transmission, e.g., for a radio tag, using the data itself and without using an explicit start indicator pattern.

In accordance with embodiments, the radio transmitter apparatus is to perform a pattern detection for detecting a start indicator pattern in the data.

In accordance with embodiments, one or more detected start indicator patterns in the data are marked using a data tag.

In accordance with embodiments, the pattern detection is performed by using one or more of the following:
an autocorrelation and cross-correlation, e.g., to detect repetitive patterns and similarities between two signals,
a Fast Fourier Transform (FFT), e.g., to analyze a frequency content of a signal, which facilitates detecting periodic patterns,
a wavelet transform, e.g., for analyzing signals with varying frequencies over time and detecting transient patterns,
Hidden Markov Models (HMMs), e.g., effective for modeling time-varying patterns and detecting hidden states in a sequence of observations,
Support Vector Machines (SVM), e.g., a machine learning algorithm used for binary classification tasks, including pattern detection,
Dynamic Time Warping (DTW), e.g., to measure a similarity between two time series that may vary in length or speed, making it suitable for pattern matching,
neural networks, e.g., deep learning models like Convolutional Neural Networks (CNNs) and Recurrent Neural Networks (RNNs), which can be used for pattern detection in complex and high-dimensional data.

In accordance with embodiments, the radio transmitter apparatus is to scan the data to detect one or more or all occurrences of the start indicator pattern.

In accordance with embodiments, the radio transmitter apparatus is to scan the data by moving a window, which has a length equal to a length of the start indicator pattern, across the data, and check one or more or all of the segments for a match with the start indicator pattern.

In accordance with embodiments, the window comprises in one or more of the following:
a time window, e.g., the length measured in milliseconds or multiples thereof,
a sampling window, e.g., the length measured in a number samples,
a bit window, e.g., measured in a number of bits collected in a given time period.

In accordance with embodiments, the radio transmitter apparatus is to divide the data into fixed-size segments, which have a length equal to a length of the start indication pattern, and check a pattern in one or more or all of the segments for a match with the start indicator pattern.

In accordance with embodiments, checking the pattern in the one or more or all segments for a match with the start indicator pattern comprises one or more of the following:
sequentially checking each of the segments,
using on the one or more or all segments a pattern or a bitmap, e.g., based on a pattern of segments or based on one or more bitmaps,
checking a random subset of the segments.

In accordance with embodiments, the radio transmitter apparatus is to scramble the data in the second part of the data transmission, e.g., responsive to detecting one or more start indicator patterns in the data.

In accordance with embodiments, the radio transmitter apparatus is to scramble the data in the second part of the data transmission, e.g., responsive to a number of start indicator patterns, which are detected in the second part the data transmission, exceeding a configured or preconfigured threshold.

In accordance with embodiments, the radio transmitter apparatus is to scramble the data the second part of the data transmission responsive to a likelihood of pattern detection exceeding a configured or preconfigured threshold.

In accordance with embodiments, the radio transmitter apparatus is to scramble the data the second part of the data transmission responsive to
a number of data transmissions for the plurality of radio tags, in which one or more start indicator patterns are detected, exceeding a configured or preconfigured threshold, or
a number of start indicator patterns, which are detected in data transmissions for the plurality of radio tags over a configured or preconfigured time period, exceeding a configured or preconfigured threshold.

In accordance with embodiments, the radio transmitter apparatus is to stop scrambling the data in the second part of the data transmission responsive to the likelihood of pattern detection falling below the configured or preconfigured threshold.

In accordance with embodiments, the radio transmitter apparatus is to stop scrambling the data in the second part of the data transmission responsive to one or more of the following:
a number of data transmissions for the plurality of radio tags, in which one or more start indicator patterns are detected, falling below the configured or preconfigured threshold,
a number of start indicator patterns, which are detected in data transmissions for the plurality of radio tags over a configured or preconfigured time period, falling below the configured or preconfigured threshold,
a detection of a stop indicator pattern, e.g., a configured or pre-configured pattern or bitmap or sequence.

In accordance with embodiments, the radio transmitter apparatus is to scramble the data in the second part of the data transmission using a deterministic algorithm.

In accordance with embodiments, the deterministic algorithm comprises:
an invertible function, e.g., an XOR function with a predefined mask or a linear feedback shift register (LFSR) based scrambling, or
a function computationally efficient for the radio tag, e.g., such that the descrambling function can be performed by a radio tag having no power source or a very limited batter power, having limited processing capabilities, and having limited memory.

In accordance with embodiments, the radio transmitter is to indicate to the at least one radio tag that the data the second part of the data transmission is scrambled, e.g., by providing a flag or metadata indicating that and/or how the data in the second part of the data transmission is scrambled.

In accordance with embodiments, the radio transmitter apparatus is to insert one or more bits at one or more certain positions in the data in the second part of the data transmission, e.g., such that any start indicator pattern in the data is interrupted.

In accordance with embodiments, the radio transmitter apparatus is to insert the one or more bits at one or more configured or preconfigured bit positions in the data.

In accordance with embodiments, the radio transmitter apparatus is to not to perform a start indicator pattern detection process.

In accordance with embodiments, if for a bit position, both bit values do not result in a start indicator pattern, the radio transmitter apparatus is to set the bit position to a certain value, like a default value, such as 0, or any configured or preconfigured value.

In accordance with embodiments, if for a bit position, one of the bit values results in a start indicator pattern, the radio transmitter apparatus is to set the bit position to the other one of the bit values.

In accordance with embodiments, the radio transmitter apparatus is to insert the one or more bits at the one or more certain bit positions in the data responsive to an occurrence of
a part of the start indicator pattern in the data, or
the entire start indicator pattern in the data.

In accordance with embodiments, the radio transmitter apparatus is to perform a start indicator pattern detection process for detecting the occurrence of
a part of the start indicator pattern in the data, or
the entire start indicator pattern in the data.

In accordance with embodiments, the radio transmitter apparatus is to insert one or more bits after each occurrence of a part of the start indicator pattern.

In accordance with embodiments, the radio transmitter apparatus is to freely choose a value of the inserted bit, unless a certain value results in a new start indicator within the data.

In accordance with embodiments, the radio transmitter apparatus is to choose the one or more certain positions dynamically or in accordance with a configuration or pre-configuration.

In accordance with embodiments, the one or more certain positions are positions relative to a beginning of the data or relative to a beginning of the start indicator pattern within the data.

In accordance with embodiments, the radio transmitter is to indicate to the at least one radio tag that the one or more bits have been inserted into the data, e.g., by providing a flag or metadata indicating that the radio transmitter apparatus has inserted a number of bits into the data.

In accordance with embodiments, the radio transmitter is to indicate to the at least one radio tag at which bit positions the bits have been inserted into the data.

In accordance with embodiments, the radio transmitter apparatus is to distribute one or more CRC bits over the data, e.g., such that any start indicator pattern in the data is interrupted.

In accordance with embodiments, the radio transmitter apparatus is to distribute the CRC bits such that a distance between two CRC bits is not larger than a certain length, e.g., the length of the start indicator pattern.

In accordance with embodiments, if a default CRC calculation results in a start indicator pattern within the data, the radio transmitter apparatus is to adapt the CRC.

In accordance with embodiments, the transmitter is to adapt the CRC by one or more of the following:
a scrambling of the CRC bits, e.g. according to one or more configured or preconfigured scrambling patterns,
calculating the CRC bits such that the remainder is greater than 0,
calculating the CRC bits using a different CRC generator polynomial, the different CRC generator polynomial selected from a plurality of configured or preconfigured CRC generator polynomials.

In accordance with embodiments, the radio transmitter is to indicate to the at least one radio tag
how the CRC bits are distributed in the data, or
how the CRC has been adapted.

In accordance with embodiments, the radio transmitter apparatus is to communicate with
a core network of a wireless communication system using a first communication protocol, and
the radio tag using a second communication protocol.

In accordance with embodiments,
the wireless communication system comprises one of the following: a 3GPP network or a WiFi network of an Radio-frequency identification, RFID, network,
the first communication protocol comprises one of the following:
   a 3GPP communication protocol, e.g., A-IoT or NB-IoT or eMTC or LTE-M, or
   a non-3GPP radio protocol, e.g., a WiFi communication protocol or an RFID communication protocol or a lower power wide area protocol, LPWA, e.g., mioty®, or a satellite radio protocol, e.g., Iridium®, and
the second communication protocol is the same as of different from the first communication protocol.

In accordance with embodiments, the radio tag comprises one the following:
an IoT Internet-of-Things, IoT, device,
an NB-IoT or eMTC device,
a low power wide area device, LPWA,
an Ambient IoT device,
a sensor device,
an actuator device,
a passive device,
a device without active transmitter, using backscatter communication, e.g. of a carrier wave, CW, signal,
an Radio-frequency identification, RFID, device, like an RFID tag.

In accordance with embodiments, the radio transmitter apparatus comprises one the following:
an Radio-frequency identification, RFID, device, like an RFID reader,
a mobile terminal of a wireless communication network, e.g., a user equipment, UE, of a 3GPP network or of a WiFi network, e.g., a wireless station, STA, of a WiFi network or a WiFi access point, AP,
a radio access network, RAN, entity of a wireless communication network, e.g., a base station of a 3GPP network or an access point, AP, of a WiFi network.

The present invention provides a radio tag for receiving from a radio transmitter apparatus, which serves a plurality of radio tags, a data transmission, wherein
the data transmission comprises a first part and a second part including data to be transmitted to the at least one radio tag, and
the radio tag is to process the second part of the data transmission received from the radio transmitter apparatus for obtaining from the received data transmission payload data and/or control data for the radio tag.

In accordance with embodiments,
the at least one radio tag is an Ambient IoT (A-IoT) device,
the data transmission comprises an A-IoT Reader-to-Device (R2D) signal divided into two parts, the first part including an R2D Timing Acquisition Signal (R-TAS), which includes a Start Indication Pattern (SIP) and a Clock Acquisition Part (CAP), and the second part including a physical reader-to-device channel (PRDCH) and a postamble.
the CAP of the R-TAS encodes a chip rate of a remainder of the transmission, e.g., a number of chips per OFDM symbol

$$( {M}_{chip}^{symb} ) ,$$

the value of

$${M}_{chip}^{symb}$$

according to whom the CAP is received being determined from among those given in the following table:

| Number of chips per OFDM | |
|---|---|
| $symbol ( {M}_{chip}^{symb} )$ | ${N}_{R B}^{min}$ |
| 2 | 1 |
| 6 | 1 |
| 12 | 2 |
| 24 | 3 |

a PRDCH transmission begins in chip

$$χ = {χ}_{start}^{PRDCH} ,$$

where:

$${χ}_{start}^{PRDCH} = {N}_{SIP} + {N}_{CAP} ,$$

and
an R2D transport block size is

$${N}_{TBS}^{R 2 D} .$$

In accordance with embodiments,
the second part of the A-IoT Reader-to-Device (R2D) signal comprises padding chips that are set to any values which do not result in another R-TAS SIP,
the mapping to chips is as follows:
to chips χ=0 and up are mapped:
   the bits of the R-TAS SIP in sequence starting with S₀ followed by
   the bits of the R-TAS CAP in sequence starting with A₀ followed by
   the bits of PRDCH in sequence starting with c₀ followed by
   the bits of the R2D postamble in sequence starting with P₀,
if

$${M}_{chip}^{symb} = 24 ,$$

chips χ=χ′, χ′+1 satisfying (χ′−N_{SIP}) modulo

$${M}_{chip}^{symb} = {M}_{chip}^{symb} - 2$$

are skipped for the mapping of PRDCH and the R2D postamble, and are instead set to values of 1, and
following postamble bit P₃, the smallest integer N_{pad}≥0 padding chips are inserted, if needed, until

$$( {M}_{chip}^{R 2 D} - {N}_{SIP} )$$

modulo

$${M}_{chip}^{symb} = 0 ,$$

with the padding chips set to any values which do not result in another R-TAS SIP, and wherein if

$${M}_{chip}^{symb} = 24 ,$$

values of 1 are mapped to the final two padding chips.

In accordance with embodiments, the first part includes a start indicator of the at least one radio tag.

In accordance with embodiments, the first part contains control signaling associated with the second part of the data transmission.

In accordance with embodiments, the first part contains a data channel, which may or may not be associated with the second part of the data transmission.

In accordance with embodiments, the first and/or second part of the data transmission comprises one of more of the following:
a transmission of data, like payload data and/or control data,
a retransmission of data, like payload data and/or control data, e.g., a transmission of previously transmitted data,
a redundancy transmission of data, like payload data and/or control data, e.g., a transmission of an exact copy of the data or a redundancy version of the data, e.g., previously transmitted data and/or data stored in a data buffer of the radio transmitter apparatus
control signaling,
DCI downlink control information,
Downlink and/or uplink grant,
SCI sidelink control information
HARQ feedback information,
random access, RA, information.

In accordance with embodiments, the second part of the data transmission has been processed prior to transmission such that the data is free of a pattern representing a start indicator for one or more of the plurality of radio tags.

In accordance with embodiments, the second part of the data transmission has been processed using one or more of the following:
data scrambling,
data interleaving,
bit insertion,
bit extraction or deletion,
Cyclic Redundancy Check, CRC, adaption.

In accordance with embodiments, the radio tag is to identify a correct scrambling function for obtaining the data from the second part of the data transmission
responsive to an indication received from the radio transmitter apparatus which indicates how the second part of the data transmission has been scrambled, or
by blind decoding a plurality of different scrambling patterns in case the data transmission is initially not decodable and determining the correct scrambling pattern responsive to a matching CRC.

In accordance with embodiments, the radio tag is to descramble the second part of the data transmission using an inverse of the correct scrambling pattern to obtain the data from the second part of the data transmission.

In accordance with embodiments, the radio tag is to determine the data from the second part of the data transmission by identifying one or more inserted bits in the data
responsive to an indication received from the radio transmitter apparatus which indicates bit positions at which the one or more bits have been inserted into the data, or
by blind decoding the second part of the data transmission.

In accordance with embodiments, the radio tag is to determine the data from the second part of the data transmission by identifying CRC bits, which are distributed in the data,
responsive to an indication received from the radio transmitter apparatus which indicates bit positions at which the distributed CRC bits have been inserted into the data, or
by blind decoding.

In accordance with embodiments, the radio tag is to remove one or more bits at one or more certain positions in the data in the second part of the data transmission, e.g. according to a pre-defined rule to interrupt potential start indicator patterns.

In accordance with embodiments, the radio tag is to remove the one or more bits at one or more configured or preconfigured bit positions in the data.

In accordance with embodiments, the if for a bit position, one of the bit values would result in a start indicator pattern, the radio tag is to set the bit position to the that value of the bit values.

In accordance with embodiments, the radio tag is to remove the one or more bits at the one or more certain bit positions in the data to unscramble the transmission that contains
a part of the start indicator pattern in the data, or
the entire start indicator pattern in the data.

In accordance with embodiments, the radio tag apparatus is to remove one or more bits after each occurrence of a part of the start indicator pattern.

In accordance with embodiments, the radio tag is to remove the one or more certain positions e.g. in accordance with a configuration or pre-configuration.

In accordance with embodiments, the one or more certain positions are positions relative to a beginning of the data or relative to a beginning of the start indicator pattern within the data.

In accordance with embodiments, wherein the radio tag receives an indication or control to remove one or more bits e.g., by receiving a flag or metadata indicating that the radio is to remove a number of bits from the data.

In accordance with embodiments, the radio tag receives at which bit positions the bits have to be removed from the data.

In accordance with embodiments, the radio tag comprises:
a backscatter transmitter for transmitting a signal using a backscattered signal,
wherein the radio device is to receive an incident signal from the radio transmitter apparatus and transmit the signal using the backscattered signal responsive to the incident signal.

In accordance with embodiments, the radio device comprises one the following:
an IoT Internet-of-Things, IoT, device,
an NB-IoT or eMTC device,
a low power wide area device, LPWA,
an Ambient IoT device,
a sensor device,
an actuator device,
an Radio-frequency identification, RFID, device, like an RFID tag.

The present invention provides a wireless communication network, comprising:
one or more radio tags of any one of the embodiments of the present invention, and/or
one or more radio transmitter apparatus of any of the embodiments of the present invention.

The present invention provides a method for operating a radio transmitter apparatus for transmitting a data transmission for at least one radio tag of a plurality of radio tags, wherein the data transmission comprises a first part and a second part including data to be transmitted to the at least one radio tag, the method comprising:
processing the second part of the data transmission such that the data is free of a pattern representing a start indicator for any of the plurality of radio tags.

The present invention provides a method for operating a radio tag for receiving from a radio transmitter apparatus, which serves a plurality of radio tags, a data transmission, wherein the data transmission comprises a first part and a second part including data to be transmitted to the at least one radio tag, the method comprising:
processing the second part of the data transmission received from the radio transmitter apparatus for obtaining from the received data transmission payload data and/or control data for the radio tag.

The present invention provides a computer program product comprising instructions which, when the program is executed by a computer, causes the computer to carry out one or more methods in accordance with the present invention.

### BRIEF DESCRIPTION OF THE DRAWINGS

Embodiments of the present invention will be detailed subsequently referring to the appended drawings, in which:

FIG. 1 illustrates a schematic representation of a wireless communication for implementing embodiments of the present invention,

FIG. 2 illustrates a reader device in accordance with embodiments of the present invention,

FIG. 3 illustrates a radio tag in accordance with embodiments of the present invention,

FIG. 4 illustrates a data scrambling process in accordance with embodiments of the present invention,

FIG. 5 illustrates a bit insertion process in accordance with embodiments of the present invention,

FIG. 6 illustrates a CRC adaption process in accordance with embodiments of the present invention,

FIG. 7A and FIG. 7B are schematic representations of an example of a terrestrial wireless communication network in which embodiments of the present invention may be implemented, and

FIG. 8 illustrates an example of a computer system on which units or modules as well as the steps of the methods described in accordance with the inventive approach may execute.

### DETAILED DESCRIPTION OF THE INVENTION

In the following description of embodiments of the present invention, in the accompanying drawings the same or similar elements have assigned the same reference signs.

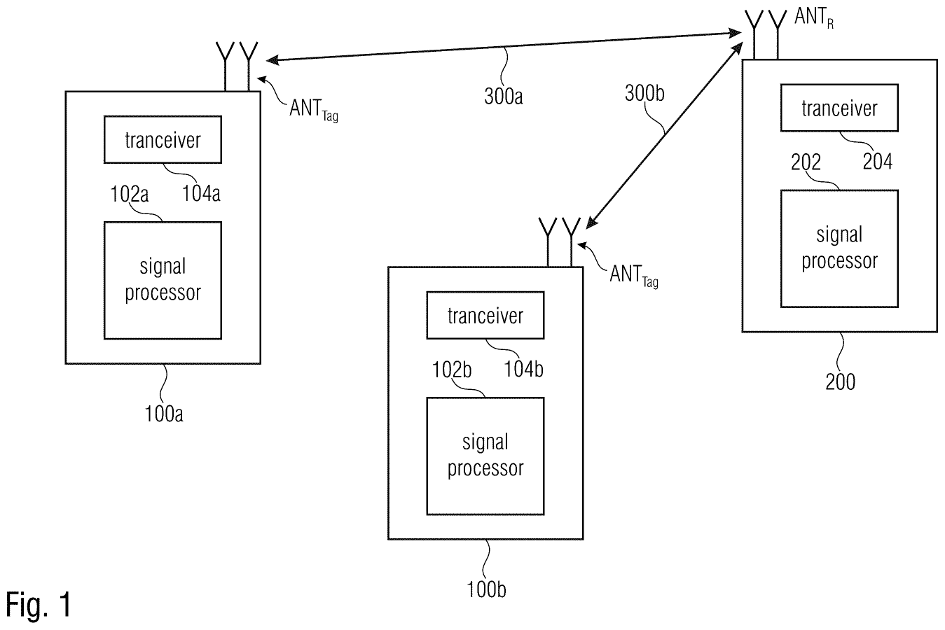

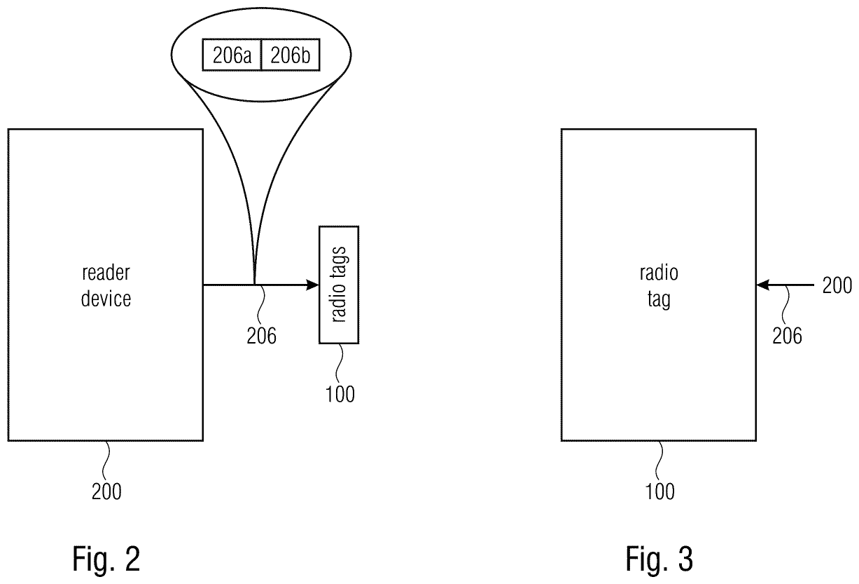

FIG. 2 illustrates a reader device 200 in accordance with embodiments of the present invention. The reader device is also referred to herein as a radio transmitter apparatus and may be a reader device as described with reference to FIG. 1. The reader device or radio transmitter apparatus 200 processes a data transmission for a radio tag, like an Ambient IoT device or an RFID device, prior to the transmission so that a part of the data transmission including the data for the radio tag, e.g., payload data and/or control data, includes no pattern, like a bit pattern, that corresponds to a pattern indication a start indicator or wakeup signal for any of a plurality of radio tags. Stated differently, the reader device or radio transmitter apparatus 200 is for transmitting a data transmission 206 for at least one radio tag of a plurality of radio tags. The data transmission 206 comprises a first part 206a including at least a start indicator of the at least one radio tag 100 and a second part 206b including data to be transmitted to the at least one radio tag 100. The radio transmitter apparatus or reader device 200 processes the second part 206b of the data transmission 206 such that the data is free of a pattern representing a start indicator for any of the plurality of radio tags. In accordance with embodiments, the reader device 200 may be a network entity of a 3GPP wireless communication network, for example a user equipment, UE, or a base station, BS, or any other radio access network, RAN, entity of the network. In accordance with other embodiments, the reader device may be a station, STA, or access point, AP, of a WiFi network. In accordance with yet other embodiments, the reader device 200 may be an RFID-reader.

In accordance with embodiments, the first part may include a start indicator, e.g., start indicator of the at least one radio tag. For example, there may be devices that do not need a start indicator, yet the second part should still be free of start indicators to avoid activating other devices. In accordance with other embodiments, the first part may contain control signaling associated with the second part of the data transmission. In accordance with other embodiments, the first part may contain a data channel, which may or may not be associated with the second part of the data transmission. In accordance with other embodiments, the start indicator may causes one or more radio tags, or group of radio tags, to be activated for a communication. In accordance with other embodiments, the first and/or second part of the data transmission may comprises one of more of the following:
a transmission of data, like payload data and/or control data,
a retransmission of data, like payload data and/or control data, e.g., a transmission of previously transmitted data,
a redundancy transmission of data, like payload data and/or control data, e.g., a transmission of an exact copy of the data or a redundancy version of the data, e.g., previously transmitted data and/or data stored in a data buffer of the radio transmitter apparatus
a control signaling,
downlink control information, DCI,
a downlink and/or uplink grant,
sidelink control information, SCI,
HARQ feedback information,
random access, RA, information.

In accordance with other embodiments, the start indicator comprises one or more of the following:
a preamble,
one or more pilot symbols, e.g., a configured or preconfigured pattern of symbols,
a Zadoff-Chu sequence.

FIG. 3 illustrates a radio tag or radio device 100 in accordance with embodiments of the present invention, which may be a radio tag as described with reference to FIG. 1. The radio tag receives from a transmitter, like a reader device 200 of FIG. 2, a data transmission and processes a second part of the data transmission for obtaining the data for the radio tag, e.g., payload data and/or control data.

Stated differently the radio tag 100 is for receiving from a radio transmitter apparatus, e.g., the reader device 200 in FIG. 2, which serves a plurality of radio tags, a data transmission 206. The data transmission 206 comprises a first part 206a including at least a start indicator of the at least one radio tag 100 and a second part 206b including the data to be transmitted to the at least one radio tag. The radio tag 100 processes the second part 206b of the data transmission 206 received from the radio transmitter apparatus or reader device 200 for obtaining from the received data transmission 206 payload data and/or control data for the radio tag 100. In other words, the beginning or first part of the data transmission does have a start indicator, e.g., for waking up the radio tag. However there is not any start indicator in the remainder or second part of the data transmission. A next slot/data transmission again starts with a start indicator in a first part thereof followed by a second part holding the data. The radio tag may be a device operating in accordance with the 3GPP standard. In accordance with other embodiments, the radio tag 100 may be a device operating in accordance with the WiFi standard. In accordance with yet other embodiments, the radio tag 100 may be an RFID device, like an RFID tag.

In accordance with embodiments, the first part includes a start indicator of the at least one radio tag. In accordance with other embodiments, the first part contains control signaling associated with the second part of the data transmission. In accordance with other embodiments, the first part contains a data channel, which may or may not be associated with the second part of the data transmission. In accordance with other embodiments, the first and/or second part of the data transmission comprises one of more of the following:
a transmission of data, like payload data and/or control data,
a retransmission of data, like payload data and/or control data, e.g., a transmission of previously transmitted data,
a redundancy transmission of data, like payload data and/or control data, e.g., a transmission of an exact copy of the data or a redundancy version of the data, e.g., previously transmitted data and/or data stored in a data buffer of the radio transmitter apparatus control signaling,
DCI downlink control information,
Downlink and/or uplink grant,
SCI sidelink control information
HARQ feedback information, random access, RA, information.

In accordance with other embodiments, the second part of the data transmission has been processed prior to transmission such that the data is free of a pattern representing a start indicator for one or more of the plurality of radio tags.

By providing a data transmission in a way that the data to be transmitted in the data portion thereof, like payload data or control data, does not include a certain pattern, like a bit pattern also representing a start signal or wake-up signal for a radio tag, the problems discussed above with regard to a possible loss of synchronization, data corruption or increase in power consumption are avoided as false detections of a start signal are reduced or avoided. With the data transmission, only the actual start signal or wake-up signal for the intended receiver, radio tag; is transmitted in the first part of the data transmission.

In accordance with embodiments, the second part of the data transmission may include one or mor of the following:
Data, i.e., new data, like payload data and/or control data.
A retransmission of data, for example a transmission of a previously transmitted data portion which may be required in case the earlier transmission has not been completely received or in case a part of the earlier transmission has not been decoded successfully by the radio tag.
A redundancy transmission, for example responsive to a non-successful first transmission. The redundancy transmission may be an exact copy or a redundancy version of a data portion. The data to be transmitted may be data that has been previously transmitted or may be data that has been buffered in a data buffer of the radio transmitter apparatus or reader device.

Embodiments of the present invention avoid patterns within the data portion (second part) of the data to be transmitted which correspond or may be decoded as patterns identifying a start signal or wake-up signal for a radio tag not being the intended recipient for the transmission. The start indicator may have different forms, for example it may be a preamble, e.g., a sequence or a pattern of different low and high voltage transmissions, or may be formed of one or more pilot symbols, like a configured or preconfigured pattern of symbols. In accordance with other embodiments, the start indicator may be a Zadoff-Chu sequence. The Zadoff-Chu sequence may have one or more of the following properties:
Constant Amplitude: The Zadoff-Chu sequence has a constant amplitude, which simplifies the signal processing and detection at the receiver.
Low Autocorrelation Sidelobes: The autocorrelation properties of Zadoff-Chu sequences exhibit low sidelobes, which helps in achieving good synchronization performance and reducing interference.
Orthogonality: Zadoff-Chu sequences are orthogonal to each other, making them suitable for multiple access communication systems where multiple users share the same frequency band.
Doppler Tolerance: Zadoff-Chu sequences are known for their robustness against Doppler shifts, which can occur in mobile communication scenarios.
Linear Phase: The Zadoff-Chu sequences have a linear phase characteristic, which simplifies signal processing and synchronization tasks.
Variable Length: Zadoff-Chu sequences can be generated with different lengths, providing flexibility in designing communication systems with different requirements.
Overall, the characteristics of Zadoff-Chu sequences make them a popular choice for synchronization and channel estimation in wireless communication systems, especially in LTE and 5G standards.

Embodiments of the present invention take into account the constraints or restrictions the radio tags are subjected to especially for avoiding a substantial increase in the data size as it is experienced in conventional bit or byte stuffing techniques, avoiding a higher complexity of the data signal thereby avoiding the increase in the processing power and memory required for handling a larger amount of data and more advanced encoding schemes, and avoiding any additional computations and transmissions which consume additional energy.

In accordance with embodiments, this is achieved by processing the second part of the data transmission before transmitting the data transmission using one or more of the following:
data scrambling, or
data interleaving, or
bit insertion, or
bit extraction, or
Cyclic Redundancy Check, CRC, adaption.

In accordance with further embodiments, processing the data prior to the data transmission may also include creating a data start indication for the receiving radio tag which is included into the first part of the data transmission so that following the start indicator or wake-up signal used for activating the radio tag for the communication, using the data start indication allows the radio tag to determine an immediately upcoming data transmission. The data start indication may be created using the data to be transmitted itself and without using any explicit start indicator pattern. For example, this can be achieved by coding a specific sequence of bits or a predefined code that represents the start signal within the data message. This could be included as a header or prefix to the message to indicate to the receiving device that it should interpret the following data as a wake-up signal, or the data could be arranged in such a way, that a radio tag can perform a function on the data, e.g., a correlation or auto-correlation function, in such a way, that it can detect a peak and thus interpret the received data signal as a start indication.

In accordance with embodiments, the detection and avoidance of a start indicator pattern within the data to be transmitted from the reader device 200 to a radio tag 100 may include detecting and avoiding patterns or parts of patterns which are similar to a start indicator pattern. The detection and avoidance of the start indicator pattern may include detecting and avoiding parts of the pattern or patterns similar to the start indicator pattern. Any detected pattern or part of a pattern may be marked in the data using a data tag so as to indicate a position at which a modification of the data may be required. An actual detection of a pattern or parts of a pattern may be performed using one or more of the following:
An autocorrelation and cross-correlation, e.g., to detect repetitive patterns and similarities between two signals.
A Fast Fourier Transform (FFT), e.g., to analyze a frequency content of a signal, which facilitates detecting periodic patterns.
A wavelet transform, e.g., for analyzing signals with varying frequencies over time and detecting transient patterns.
Hidden Markov Models (HMMs), e.g., effective for modeling time-varying patterns and detecting hidden states in a sequence of observations.
Support Vector Machines (SVM), e.g., a machine learning algorithm used for binary classification tasks, including pattern detection.
Dynamic Time Warping (DTW), e.g., to measure a similarity between two time series that may vary in length or speed, making it suitable for pattern matching.
Neural networks, e.g., deep learning models like Convolutional Neural Networks (CNNs) and Recurrent Neural Networks (RNNs), which can be used for pattern detection in complex and high-dimensional data.

In accordance with embodiments, the reader device 200 may scan the data to be transmitted for detecting one or more or all occurrences of the start indicator pattern or a part thereof within the data to be transmitted. In accordance with embodiments, the data may be scanned by moving a window which has a length equal to a length of the start indicator pattern or the part of the starting detector pattern across the data and to check one or more or all of the segments for a match with the start indicator pattern. The window may be a time window having a length measured in milliseconds or multiples thereof, or a sampling window having a length measured in a number of samples, or a bit window measured in a number of bits collected in a given time period.

In accordance with other embodiments, for detecting a pattern in the data, the data may be divided into fixed-size segments having a length equal to a length of a start indicator pattern or a part thereof and checking for a pattern match in one or more or all of the segments. The checking may include a sequential checking of each of the segments, e.g., every segment is checked from the beginning to the end of the data chunks, or a checking of a random subset of the segments, e.g., segments are selected randomly for comparison with the start indicator pattern, or by applying on the one or more or all segments a pattern or bit map, for example based on a pattern of segments or based on one or more bit maps. The bitmap could specify that only specific bits within each segment are compared with the pattern. For instance, if a predefined sequence of a given length, e.g., 1110, appears at the start of each segment, this may signal the beginning of a data sequence without needing to check the entire segment.

### Data Scrambling

In accordance with embodiments of the present invention, the data to be transmitted to the radio tag may be scrambled using a deterministic algorithm before the transmission to ensure that the start indicator pattern does not appear within the data payload or within the control data to be transmitted in the second part of the data transmission.

A pattern detection is performed prior to the transmission so as to scan the data for any occurrences of the start indicator pattern, for example in a way as described above. If a start indicator pattern is detected within the data, a scrambling function is applied which is designed to modify the data in a way that the start indicator pattern is eliminated. By simply scrambling the original data for avoiding the appearance of a start indicator pattern the overall amount of data remains unchanged thereby avoiding the drawbacks of conventional techniques, like the bit stuffing approach or the byte stuffing approach. Also, the data scrambling approach is a simple processing technique and at the radio tag, the original data may be retrieved by simply descrambling the received data which is a process requiring substantially less processing power and memory when compared to processing larger amounts of data or using advanced coding schemes as applied in conventional technology approaches.

In accordance with embodiments, the data scrambling may only be applied if a detected start indicator pattern reaches a predetermined threshold, for example, within a specific time window or over a number of transmissions. In case the number of detected start indicator patterns increases beyond a threshold, it may be assumed that a likelihood of a pattern detection increases and therefore scrambling is applied. However, when the number of detected start indicator patterns falls below the threshold the likelihood of detecting a pattern with transmission as a start signal pattern also decreases and therefore a scrambling may be stopped. This process is also referred to as a conditional scrambling process.

In accordance with further embodiments, the scrambling may also be stopped responsive to detecting a stop indicator pattern, for example a configured or pre-configured pattern or bitmap or sequence. For instance, the stop pattern could be configured via RRC or MAC-CE or physical layer control signaling, or it could also appear at the beginning or the middle or the end of the control part of the frame. Additionally it could be provided in a previous control frame, e.g., a trigger frame.

In a further embodiment additional information about the scrambling may be indicated. This may be the scrambling type/sequence, the start and or end of the scrambled part of the data transmission or the length of the scrambled section.

In accordance with embodiments, a deterministic algorithm may be used for scrambling the data of the data transmission for avoiding the occurrence of start signal indicators in the data transmitted to a radio tag. In accordance with embodiments, for the scrambling process, a deterministic algorithm may be selected yielding a low memory and computational footprint thereby avoiding any substantial increase in the required processing of the data at the radio tag thereby avoiding the conventional technology problems with the use of enhanced coding schemes and the associated high processing/memory requirements. The deterministic algorithm, in accordance with embodiments, may be
an invertible function, e.g., an XOR function with a predefined mask or a linear feedback shift register (LFSR) based scrambling, or
a function computationally efficient for the radio tag, e.g., such that the descrambling function can be performed by a radio tag having no power source or a very limited batter power, having limited processing capabilities, and having limited memory.

In accordance with further embodiments, the scrambling may be indicated by the reader device towards the radio tag. For example, a flag or metadata may be included into the data transmission, e.g., into a first part thereof also carrying the ID of the radio tag for which the data transmission is intended. Thereby, the radio tag may be informed that a scrambling has been applied and/or which scrambling pattern or mask has been used, i.e., how the data has been scrambled.

In accordance with other embodiments, the radio tag may not be provided with an indication of the scrambling applied to the data prior to its transmission from the reader device to the radio tag. In such situations, the radio tag may not be capable to decode the received data transmission initially and determines that some kind of descrambling is required. The radio tag may apply and decode difference scrambling patterns for determining the correct scrambling pattern by mentioning the CRC.

In a further embodiment the tag may blind decode the data by applying each potential scrambling pattern one at a time. Then, for each potential scrambling pattern it tries to reverse the scrambling applied at the received data. After each decoding attempt, the tag calculates the CRC for the resulting data, and compares it to the original CRC attached to the received data. When both CRCs match, the radio tag knows the pattern applied is the correct one. The radio tag or device tries decoding the data after applying the one or more descrambling patterns, and it knows that the process was successful when the CRC is correct.

In another embodiment the tag may blind decode the data by applying each potential scrambling pattern one at a time. For each potential scrambling pattern it tries to reverse the scrambling applied at the original data. After each decoding attempt, the tag calculates the CRC for the resulting data and when the CRC is correct, the radio tag knows the pattern applied is the correct one.

The radio tag is aware of the scrambling function applied to the data, either from the explicitly signaling or from the implicit determination, and applies an inverse of the scrambling function to recover the original data. When using a deterministic scrambling algorithm, the original data integrity is maintained.

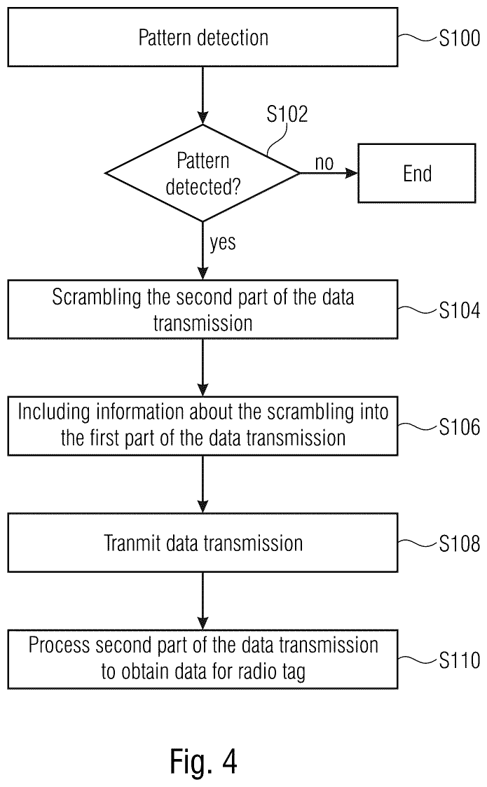

Thus, in accordance with embodiments of the present invention, avoiding the appearance of a start indicator pattern within the second part or data portion of the data transmission is achieved by performing a data scrambling process as illustrated in FIG. 4. As is illustrated, initially, a pattern detection S100 is performed, for example in a way as described in detail above. At S102 it is determined whether the second part of the data transmission includes a start indicator pattern. If no, the process ends or stops and the data transmission may be performed without any modification of the second part of the data position. On the other hand, if S102 determines that a pattern has been detected, the data in the second part of the data transmission is scrambled S104, for example by applying a conditional or non-conditional scrambling as described above. Following the scrambling S104, optionally, the scrambling of the data in the second part of the data portion may be signaled S106, for example by including into the first part of the data transmission an indication that the data in the second part has been scrambled and/or how the data has been scrambled, for example by indicating the scrambling function that has been used. Then the data transmission is transmitted S108 by the reader device to the radio tag which processes S110 the second part of the data transmission, for example on the basis of information obtained from the first part of the data transmission, indicating information about the scrambling applied for descrambling the data in the second part for obtaining the payload data or control data intended for the radio tag 100.

### Bit Insertion

In accordance with other embodiments, the reader device may insert bits at certain positions of the data to be transmitted to the reader tag, for example, at certain positions in the payload data and/or the control data thereby preventing a pattern of the starting indicator in the data. The reader device may process the second part of the data transmission including the data for the radio tag by inserting the bits at certain positions using a static insertion scheme or a dynamic insertion scheme.

In accordance with the static insertion scheme, the reader device inserts one or more filler bits at preconfigured bit positions in the second part of the data transmission. The preconfigured positions are known by the reader device and by the radio tag and are distributed over the entire second part of the data transmission in such a way that any sequence or pattern representing a start indicator is interrupted. The filler bits are not part of the data to be transmitted, and the radio tag knows the position where the filler bits are inserted. When receiving the data transmission the radio tag simply ignores the filler bits. Thus, when compared to conventional approaches using bit stuffing and byte stuffing, since the filler bit positions are known at the radio tag and are simply ignored when decoding the data transmission the inventive process of bit insertion does not increase the processing burden at the radio tag other than conventional bit stuffing or byte stuffing approaches requiring additional processing going way beyond a simple ignoring of certain bit positions.

Thus, the only purpose of the filler bits is to set these bits in such a way that no start indicator sequence or pattern is generated within the data pattern or sequence. For example, if for a preconfigured bit position both bit values 1 and 0 do not result in a start indicator pattern, the radio device may set the bit position to a devoid value, such as 0 or to any of the values dependent on a configuration of the reader device. However, if in a certain bit position a certain bit value, e.g., 0, results in a start indicator sequence, the reader device fills the certain bit position with the other bit value, e.g., 1, for interrupting a start indicator sequence or pattern.

In accordance with the dynamic insertion scheme, the reader device may insert the filler bits only if required, for example, only responsive to detecting the presence of a start indicator pattern or sequence in the second part of the data transmission. The detection of such a pattern may be performed in a way as described above. Assuming, for example, a data sequence or pattern in the second part of the data transmission to be as follows: 0010100010010, and assuming that a start indicator sequence or pattern is represented by “010001”, the reader device does not include this pattern or sequence in the second part of the data transmission because some of the radio tags may interpret this as a start indicator leading to the problems discussed above with regard to conventional approaches. Instead, the reader device inserts a bit which interrupts the start indicator pattern within the data pattern so that in the above example, the processed data in the second part of the data transmission looks as follows: 00101100010010.

The reader device may fully chose the value of the inserted bit, unless a certain value results in a new start indicator pattern within the data sequence. The position at which the bit is inserted may be dynamically chosen by the reader device, for example, at a configured or preconfigured position relative to the start of the second part of the data transmission, i.e., to the start of the data sequence, or relative to the start of the detected start indicator sequence or pattern within the second part of the data transmission, i.e., within the data sequence or pattern. A control message may indicate one or more positions where bits are inserted. These are removed for decoding and may be chosen by the reader device to interrupt any unwanted start indicator pattern. This can also be signaled by one or more starting positions and/or lengths. The position at which the bit is inserted may also be chosen or in accordance with a configuration or pre-configuration. For example, a bit mask can be specified. These bits are ignored by the radio tag and can therefore also be used by the reader device to disrupt any start indicator patterns in the data transmission.

In accordance with embodiments, the reader device may signal to the radio tag, for example, in the first part of the data transmission, that a number of bits when inserted into the data sequence included in the second part of the data transmission. In accordance with further embodiments, the reader device may indicate not only that bits having been inserted into the data sequence but also how many bits have been inserted and/or at which bit positions the bits have been inserted. In such embodiments, the radio tag is aware of the bit positions of the filler bits and, therefore, can simply ignore the filler bits thereby not adding any complexity to the decoding process at the radio tag, in a similar way as described above with reference to the static insertion scheme.

In case the reader device does not indicate to the radio tag where the respective filler bits have been inserted, the radio tag may perform a blind decoding to identify potentially inserted bits. For example, by using a check sum. which may be included in the first and or second part of the data transmission.

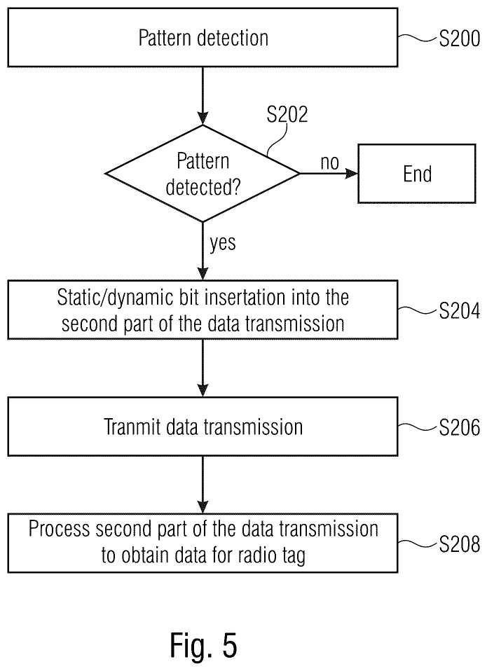

FIG. 5 illustrates an embodiment of a process for avoiding the appearance of start indicator patterns in a second part of the data transmission by using bit insertion. Initially, in similar ways described above with reference to FIG. 4, at S200, it is determined whether the second part of the data transmission, i.e., the data includes a pattern corresponding or being similar, at least in part, to a start indicator pattern. If it is determined at S202 that there is no such start indicator pattern found in the second part of the data transmission, the process ends and the reader device may transmit the data transmission to the radio tag without any modification. In case a start indicator pattern is detected, the reader device performs a static or dynamic bit indication S104, in a way as described above in more detail. Following the bit insertion, the reader device transmits S206 the processed data transmission to the radio tag 100, and the radio tag 100 processes S208 the second part of the data transmission in the above-described way for obtaining the payload data and/or control data intended for the radio tag.

### CRC Adaption

In accordance with further embodiments, the reader device may adapt a Cyclic Redundancy Check, CRC. The CRC may be adapted to prevent a start indicator pattern from being sent as part of the data included in the second part of the data transmission. In accordance with the embodiments, the CRC bits may be distributed over the entire second part of the data transmission, i.e. over the entire actual data to be transmitted to the radio tag. The distribution is such that a distance between two CRC bits is not larger than a length of a start indicator pattern.

In accordance with further embodiments, the actual generation or calculation of the CRC may itself lead to a start indicator pattern so that despite the fact that the data in the second part of the data transmission does not include a start indicator pattern, the default CRC nevertheless introduces into the data portion or second part of the transmission a start indicator pattern. In such a situation, the reader device adapts the CRC so that no start indicator pattern exists in the second part of the data transmission. In accordance with the embodiments, the reader device may scramble the CRC bits. For example, the reader may be configured or preconfigured with one or more scrambling patterns for scrambling the CRC bits. Responsive to determining that the default CRC calculation resulted in a start indicator sequence or pattern, the reader device may use a first one of the scrambling patterns for scrambling the CRC bits. If the scrambled pattern again results in a start indicator, a mixed scrambling pattern may be used until the scrambled CRC bits no longer resemble a start indicator pattern within the second part of the data transmission. In accordance with other embodiments, a remainder of the CRC, for example the CRC bits, may be calculated such that the remainder results in 1. Conventionally, a correct reception is determined if the polynomial division results in a remainder of 0, however, in accordance with embodiments the reader device may calculate the CRC bits in such a way that the remainder results in a certain value, for example 1. This also changes the value of the CRC bits which, in turn, may avoid that the CRC bits resemble a start indicator sequence. For example, when the default CRC calculation having a remainder of 0 results in a start indicator sequence, the CRC bits may be calculated with a remainder of 1, and if the obtained CRC bits do not resemble the start indicator sequence or pattern, the process is stopped. However, if also these CRC bits resemble the start indicator pattern, the CRC bits are calculated with a different remainder, for example 2, and the process may be repeated until the calculated CRC bits no longer resemble a start indicator sequence.

In accordance with yet other embodiments, responsive to a default CRC calculation resulting in a start indicator sequence, the reader device may use a different CRC generator polynomial. For example, the reader device may be configured or preconfigured with a plurality of CRC generator polynomials so that, when using one of the CRC generator polynomials for calculating the default CRC bits, which result in a start indicator sequence or pattern, the reader device uses different polynomials in a certain order until CRC bits are obtained, which do not resemble a start indicator sequence or pattern in the data sequence of the second part of the data transmission.

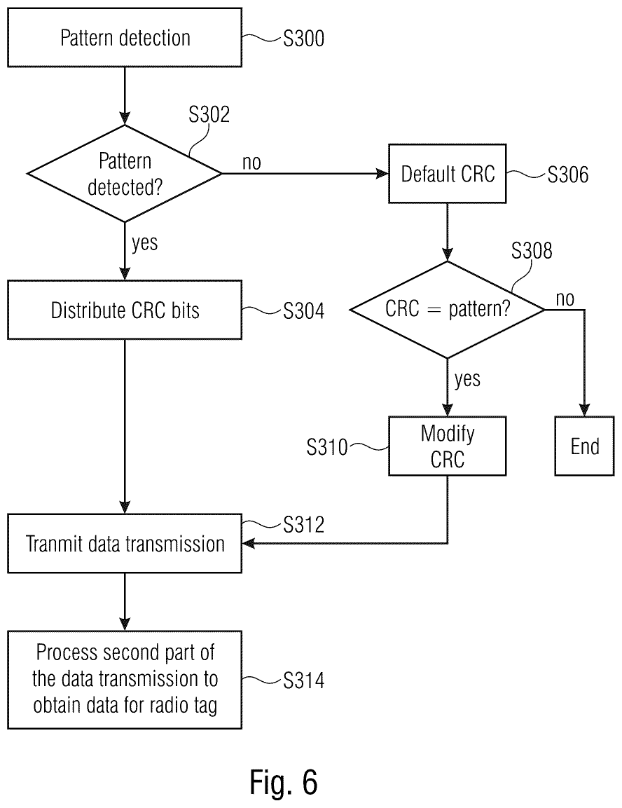

FIG. 6 illustrates an embodiment of a process for adapting the CRC in accordance with embodiments of the present invention for avoiding the appearance of a start indicator pattern in the second part of the data transmission. Initially, a pattern detection S300 may be performed in a way as described above. In case a pattern is detected, the CRC bits are distributed S304 over the second part of the data transmission for interrupting any start indicator pattern as described above. In case there is no pattern in the data portion or second part of the data transmission, the process determines S306 a default CRC and whether or not the default CRC calculation resulted in a start indicator sequence or pattern S308. If it is determined at S308 that no start indicator sequence pattern is created by the initial or default CRC calculation, the process ends and the reader device may transmit the data transmission without any processing of the second part thereof to the radio tag 100. In case it is determined that the default calculation results in a start indicator pattern, the CRC is modified S310 in the above-described way, for example by scrambling the CRC bits or using a calculation resulting in a different remainder or using a different CRC generator polynomial so that the CRC no longer resembles the start indicator pattern. Following the modifications of the data at S304 or at S310, the data transmission including the processed second part thereof is transmitted S312, the radio tag processes S314 the second part of the data transmission for obtaining the payload data and/or control data intended for the radio tag.

In accordance with embodiments, the radio tag or device tries decoding the data after applying the one or more bit insertions and knows that the process was successful when the CRC is correct. In accordance with embodiments, the radio tag removes one or more bits at one or more certain positions in the data in the second part of the data transmission, e.g. according to a pre-defined rule to interrupt potential start indicator patterns. In accordance with other embodiments, the radio tag removes the one or more bits at one or more configured or preconfigured bit positions in the data. In accordance with other embodiments, if for a bit position, one of the bit values would result in a start indicator pattern, the radio tag sets the bit position to the that value of the bit values. In accordance with other embodiments, the radio tag removes the one or more bits at the one or more certain bit positions in the data to unscramble the transmission that contains a part of the start indicator pattern in the data, or the entire start indicator pattern in the data. In accordance with other embodiments, the radio tag removes one or more bits after each occurrence of a part of the start indicator pattern. In accordance with other embodiments, the radio tag removes the one or more certain positions e.g. in accordance with a configuration or pre-configuration. In accordance with other embodiments, the one or more certain positions are positions relative to a beginning of the data or relative to a beginning of the start indicator pattern within the data. In accordance with other embodiments, the radio tag receives an indication or control to remove one or more bits e.g., by receiving a flag or metadata indicating that the radio is to remove a number of bits from the data. In accordance with other embodiments, the radio tag receives at which bit positions the bits have to be removed from the data.

In accordance with embodiments, the above mentioned removal of bits may comprise a puncturing.

### Further Embodiments

In accordance with embodiments, the radio tag is an Ambient IoT (A-IoT) device and the reader device 200 of FIG. 2 provides an A-IoT Reader-to-Device (R2D) signal have the above described first and second parts. Stated differently, the A-IoT R2D signal is logically divided into two parts. The first part prepares a device, like an A-IoT device, for the subsequent decoding of the transmission, and may one or more of the following purposes: activate the device, provide a control signaling, provide synchronization. In accordance with embodiments, the first part is referred to as a R2D Timing Acquisition Signal (R-TAS), which comprises a Start Indication Part (SIP) and a Clock Acquisition Part (CAP). The SIP provides a recognizable sequence that enables the device to differentiate an A-IoT signal from noise or other transmissions, while the CAP provides additional control signaling and clock synchronization for an accurate decoding of the subsequent payload. The second part of the transmitted signal corresponds to the remainder of the signal, and includes a Physical reader-to-device channel (PRDCH), i.e., payload, a postamble and padding.

Stated differently, between the Ambient IoT (A-IoT) device and the reader device 200 of FIG. 2 a reader to device (R2D) channel is provided, and the R2D channel corresponds to a set of chips carrying information originating from higher layers. An R2D signal is used by the physical layer, but does not carry information originating from higher layers. Thus following R2D physical channel and signals are defined:
Physical reader-to-device channel, PRDCH.
R2D timing acquisition signal, R-TAS, which consists of a start indicator part, SIP, and a clock acquisition part, CAP.
R2D postamble signal.

As stated earlier, a technical challenge arises in that a certain sequence within the second part of the transmitted signal may unintentionally resemble the SIP. When this occurs, a receiving device may falsely interpret such a sequence as a beginning of a new transmission, resulting in the problems described earlier, like decoding errors. To address this risk, embodiments of the present invention provide a mechanism for processing the second part of the transmitted signal to ensure that no unintended SIP patterns are present.

In accordance with embodiments, the mechanism uses bit or chip insertion when processing the second part of the signal to avoid the occurrence of sequences that unintentionally replicate the SIP pattern. When using bit or chip insertion, additional bits or chip are introduced into the second part of the signal to deliberately break any sequence that may resemble the start indication. The bits or chips used for insertion are also referred to as filler or padding bits or padding chips that are added with the explicit requirement that they must not form another SIP pattern. In accordance with embodiments, processing the second part of the signal comprises performing the padding dynamically at runtime to avoid any resemblance of the SIP. Thus, the bit or chip insertion approach is to insert bits or chips at one or more positions in the second part of the transmission. These positions may be flexibly configured or fixed in advance. By selecting specific insertion points, the transmitter may deliberately disrupt any data sequences that otherwise replicates a SIP pattern, thereby ensuring that the receiver does not falsely interpret such sequences as the beginning of a new signal.

In accordance with embodiments, the bit or chip insertion approach may be implemented using padding or filler bits/chips that are explicitly defined to occupy known positions in the frame. Therefore, if the padding positions are defined, the bit or chip insertion positions are also defined, ensuring that the second part of the transmission remains free of SIP-like sequences without ambiguity for the receiver.

In accordance with embodiments, padding chips may be used that are set to any values which do not result in another R-TAS SIP. For example, for an R2D transmission the mapping to chips may be as follows:

To chips χ=0 and up are mapped:
the bits of the R-TAS SIP in sequence starting with S₀ followed by
the bits of the R-TAS CAP in sequence starting with A₀ followed by
the bits of PRDCH in sequence starting with c₀ followed by
the bits of the R2D postamble in sequence starting with P₀, except if

$${M}_{chip}^{symb} = 24 ,$$

chips χ=χ′, χ′+1 satisfying (χ′−N_{SIP}) modulo

$${M}_{c h i p}^{s y m b} = {M}_{c h i p}^{s y m b} - 2$$

are skipped for the mapping of PRDCH and the R2D postamble, and are instead set to values of 1.

Following postamble bit P₃, the smallest integer N_{pad}≥0 padding chips are inserted, if needed, until

$$( {M}_{c h i p}^{R 2 D} - {N}_{SIP} )$$

modulo

$${M}_{c h i p}^{s y m b} = 0.$$

The padding chips are set to any values which do not result in another R-TAS SIP, and if

$${M}_{c h i p}^{s y m b} = 24$$

values of 1 are mapped to the final two padding chips.

In accordance with embodiments, once an A-IoT device determines that the incoming transmission is indeed an A-IoT signal, it also obtains the additional information required for a correct reception of the subsequent payload. This information is needed before the payload is received and is, therefore, provided in the first part of the signal. In accordance with embodiments, this may be implemented by the above mentioned CAP of the R-TAS, which encodes the chip rate of the remainder of the transmission, i.e., the number of chips per OFDM symbol

$$( {M}_{c h i p}^{s y m b} ) .$$

Following the correct reception of the R-TAS comprising SIP and CAP, the device can then reliably decode the PRDCH. For instance, the physical layer procedures for the R2D related procedures may include a device procedure for R-TAS reception and a device procedure for PRDCH reception.

In accordance with the device procedure for R-TAS reception a device shall, upon determining that a SIP of R-TAS has been received, determine the value of

$${M}_{c h i p}^{s y m b}$$

according to which the CAP is received from among those given in the following table:

| Number of chips per OFDM | |
|---|---|
| $symbol ( {M}_{chip}^{symb} )$ | ${N}_{R B}^{min}$ |
| 2 | 1 |
| 6 | 1 |
| 12 | 2 |
| 24 | 3 |

In accordance with the device procedure for PRDCH reception a device shall, upon receiving R-TAS, assume that a PRDCH transmission begins in chip

$$χ = {χ}_{s t a r t}^{P R D C H} ,$$

receive the assumed PRDCH and attempt to decode the corresponding R2D transport block, where:

$${χ}_{s t a r t}^{P R D C H} = {N}_{SIP} + {N}_{CAP} ,$$

and
the device can assume the R2D transport block size is

$${N}_{T B S}^{R 2 D}$$

as specified in TS 38.391, if the value is indicated by higher layers,
where, N_{SIP} and N_{CAP} refer to the number of bits in the R-TAS SIP and R-TAS CAP, respectively, and

$${N}_{T B S}^{R 2 D}$$

refers to the size of an R2D transport block.

In accordance with embodiments, an A-IoT signal detection is performed according to an envelope detection mechanism in the device, which examines a waveform's amplitude envelope to verify whether it matches a known start pattern. The start pattern may take one of the following forms: a Zadoff-Chu sequence, a preamble, or a predefined symbol pattern, like a set of configured or preconfigured pilot symbols. In accordance with embodiments, the SIP pattern consists of a predefined set of symbols known between transmitter and receiver to provide a reliable reference for detection. For instance, the start pattern or start indicator part (SIP) of the R2D timing acquisition signal (R-TAS) may be implemented such that the R-TAS SIP consists of N_{SIP}=8 bits denoted S₀, S₁, S₂, S₃, S₄, S₅, S₆, S₇=1, 1, 0, 0, 1, 0, 0, 0.

### General

In the above-described embodiments, it was assumed that a complete start indicator sequence or pattern is determined and that responsive to such a determination the respective processing of the second part of the data transmission is performed. However, the present invention is not limited to such embodiments. Rather, in accordance with other embodiments, the inventive processing of the second part of the data transmission may be performed also responsive to detecting a certain part of a start indicator pattern, for example ¾ of a signal indicator pattern within the data portion or second part of the data transmission.

In the embodiments described above, reference has been made to a wireless communication system including, as illustrated in FIG. 1, the radio tags 100a and 100b and the reader device 200. In accordance with further embodiments, the wireless communication network may include a plurality of reader devices for addressing respective radio tags within their communication range.

In accordance with embodiments, the reader devices 200 may be network entities of a certain wireless communication system, for example a network entity of a 3GPP system or a WiFi system, like a user equipment, base station or relay node in the 3GPP system or a WiFi station or access point in a WiFi system. In such embodiments, the radio tags may be addressed in accordance with the respective transmission protocol used by the wireless communication system, i.e., the radio tags may be directly addressed by the network entities of the respective wireless network.

In accordance with other embodiments, the reader tags, for example the above mentioned ultra-low complexity/ultra-low power consumption devices may not operate in accordance with the communication protocols as defined by a standard of the wireless communication network to which, for example, the reader device belongs, for example they may not operate fully in accordance with the 3GPP standard or the WiFi standard. Such radio tags, like ultra-low complexity/power ambient IoT devices, may only be addressable by appropriately adapted reader devices 200, like Ambient IoT readers or scanners. In accordance with such embodiments, the reader device 200 communicates with the respective radio tags using, for example, the ALOHA protocol, and acts as an intermediate or relay node or as a gateway node to the wireless communication system. For example the IDs of the radio tags may be translated into the International mobile subscriber identity, IMSI, and/or temporary mobile subscriber identity, TMSI. The IMSI is a unique identifier associated with a SIM card of a subscriber, while the TMSI is a temporary identifier that is used to provide a level of privacy and security by avoiding transmissions of the IMSI over the air interface. In a cellular network, these identifiers are used in the identification and communication with the UEs, and the reader device 200, as an intermediate node, translates the device-IDs of the tags 100a, 100b to respective identifiers being in conformity with the communication standard of the wireless communication system. Thus, the respective radio tags may also be addressed by network entities of the wireless communication network to which the reader device is connected, thereby integrating low complexity, low power radio devices into an existing wireless communication network, like the 3GPP network or the WiFi network.

In accordance with embodiments, the one or more reader devices 200 may be configured or preconfigured with a large number of virtual addresses, for example by using ESIM so that messages may be directly forwarded from and/or to an NG-RAN node or a core network, like 5GC.

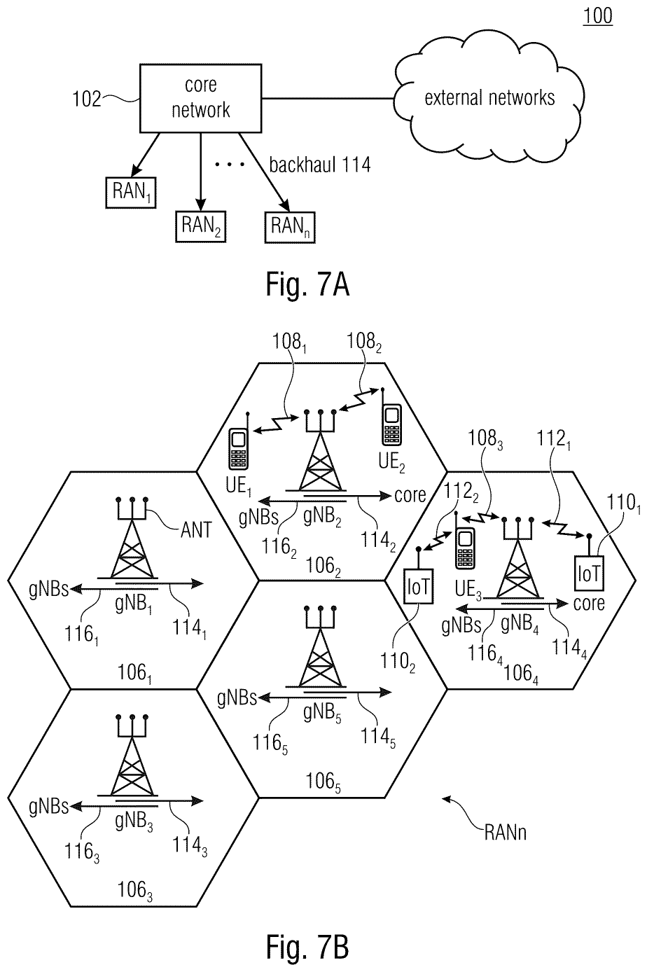

FIG. 7A and FIG. 7B schematically represent an example of a terrestrial 3GPP wireless network 400 including, as is shown in FIG. 7A, the core network, CN, 402 and one or more radio access networks, RAN₁, RAN₂, . . . , RAN_{N}. FIG. 7B is a schematic representation of an example of a radio access network RANₙ including one or more base stations gNB1 to gNB5 each serving a specific area surrounding the base station as is schematically represented by the cells 406₁ to 406₅. The base stations are provided to serve users within a cell, for example, in the licensed and/or unlicensed bands. The term base station, BS, may refer to a gNB in 5G networks, an eNB in UMTS/LTE/LTE-A/LTE-APO or just a base station in other mobile communication standards, for example a base station in a 6G network. The BS may also comprise integrated access and backhaul, IAB, modes, e.g., an IAB donor and/or an IAB node consisting of a central unit, CU, as well as distributed units, DU. FIG. 7B further illustrates the IoT devices 1001, 1002 operating in accordance with the teachings of the present invention. In accordance with first embodiments, the inventive IoT device 1001 is addressed directly by gNB4 acting as reader device 200 described above with reference to FIG. 1. On the other hand, IoT device 1002 may be a radio tag which is not addressable using the communication protocol of the wireless communication network depicted in FIG. 7(A) and FIG. 7(B). In such embodiments, UE3 acts as the reader device 200 used for addressing IoT device 1002. UE3 may act as the above described intermediate or relay node for a communication via the base station gNB4.

In accordance with other embodiments, the wireless communication network may be a WiFi network and the illustrated elements may be WiFi elements, for example the base stations illustrated may refer to an access point, AP, in any one of the WiFi standards belonging, for example, to the IEEE 802.11-family.

Although the respective aspects and embodiments of the inventive approach have been described separately, it is noted that each of the aspects/embodiments may be implemented independent from the other, or some or all of the aspects/embodiments may be combined.

In accordance with embodiments of the present invention, a user device comprises one or more of the following: a power-limited UE, or a hand-held UE, like a UE used by a pedestrian, and referred to as a Vulnerable Road User, VRU, or a Pedestrian UE, P-UE, or an on-body or hand-held UE used by public safety personnel and first responders, and referred to as Public safety UE, PS-UE, or an IoT UE, e.g., a sensor, an actuator or a UE provided in a campus network to carry out repetitive tasks and requiring input from a gateway node at periodic intervals, a mobile terminal, or a stationary terminal, or a cellular IoT-UE, or a vehicular UE, or a vehicular group leader (GL) UE, or a sidelink relay, or an IoT or narrowband IoT, NB-IoT, device, or wearable device, like a smartwatch, or a fitness tracker, or smart glasses, or a ground based vehicle, or an aerial vehicle, or a drone, or a moving base station, or road side unit (RSU), or a building, or any other item or device provided with network connectivity enabling the item/device to communicate using the wireless communication network, e.g., a sensor or actuator, or any other item or device provided with network connectivity enabling the item/device to communicate using a sidelink the wireless communication network, e.g., a sensor or actuator, or any sidelink capable network entity.

In accordance with embodiments of the present invention, a RAN network entity, like the base station or gNB, comprises one or more of the following: a macro cell base station, or a small cell base station, or a central unit of a base station, or a distributed unit of a base station, or a road side unit (RSU), or a remote radio head, or an AMF, or an MME, or an SMF, or a core network entity, or mobile edge computing (MEC) entity, or a network slice as in the NR or 5G core context, or any transmission/reception point, TRP, enabling an item or a device to communicate using the wireless communication network, the item or device being provided with network connectivity to communicate using the wireless communication network.

Although some aspects of the described concept have been described in the context of an apparatus, it is clear that these aspects also represent a description of the corresponding method, where a block or a device corresponds to a method step or a feature of a method step. Analogously, aspects described in the context of a method step also represent a description of a corresponding block or item or feature of a corresponding apparatus.

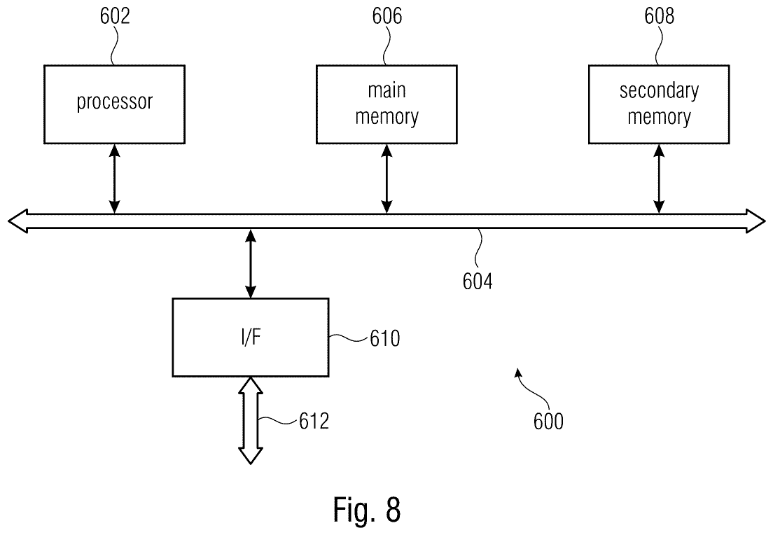

Various elements and features of the present invention may be implemented in hardware using analog and/or digital circuits, in software, through the execution of instructions by one or more general purpose or special-purpose processors, or as a combination of hardware and software. For example, embodiments of the present invention may be implemented in the environment of a computer system or another processing system. FIG. 8 illustrates an example of a computer system 600. The units or modules as well as the steps of the methods performed by these units may execute on one or more computer systems 600. The computer system 600 includes one or more processors 602, like a special purpose or a general-purpose digital signal processor. The processor 602 is connected to a communication infrastructure 604, like a bus or a network. The computer system 600 includes a main memory 606, e.g., a random-access memory, RAM, and a secondary memory 608, e.g., a hard disk drive and/or a removable storage drive. The secondary memory 608 may allow computer programs or other instructions to be loaded into the computer system 600. The computer system 600 may further include a communications interface 610 to allow software and data to be transferred between computer system 600 and external devices. The communication may be in the from electronic, electromagnetic, optical, or other signals capable of being handled by a communications interface. The communication may use a wire or a cable, fiber optics, a phone line, a cellular phone link, an RF link and other communications channels 612.

The terms “computer program medium” and “computer readable medium” are used to generally refer to tangible storage media such as removable storage units or a hard disk installed in a hard disk drive. These computer program products are means for providing software to the computer system 600. The computer programs, also referred to as computer control logic, are stored in main memory 606 and/or secondary memory 608. Computer programs may also be received via the communications interface 610. The computer program, when executed, enables the computer system 600 to implement the present invention. In particular, the computer program, when executed, enables processor 602 to implement the processes of the present invention, such as any of the methods described herein. Accordingly, such a computer program may represent a controller of the computer system 600. Where the disclosure is implemented using software, the software may be stored in a computer program product and loaded into computer system 600 using a removable storage drive, an interface, like communications interface 610.

The implementation in hardware or in software may be performed using a digital storage medium, for example cloud storage, a floppy disk, a DVD, a Blue-Ray, a CD, a ROM, a PROM, an EPROM, an EEPROM or a FLASH memory, having electronically readable control signals stored thereon, which cooperate or are capable of cooperating with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention may be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier. In other words, an embodiment of the inventive method is, therefore, a computer program having a program code for performing one of the methods described herein, when the computer program runs on a computer.

A further embodiment of the inventive methods is, therefore, a data carrier or a digital storage medium, or a computer-readable medium comprising, recorded thereon, the computer program for performing one of the methods described herein. A further embodiment of the inventive method is, therefore, a data stream or a sequence of signals representing the computer program for performing one of the methods described herein. The data stream or the sequence of signals may for example be configured to be transferred via a data communication connection, for example via the Internet. A further embodiment comprises a processing means, for example a computer, or a programmable logic device, configured to or adapted to perform one of the methods described herein. A further embodiment comprises a computer having installed thereon the computer program for performing one of the methods described herein.

In some embodiments, a programmable logic device, for example a field programmable gate array, may be used to perform some or all of the functionalities of the methods described herein. In some embodiments, a field programmable gate array may cooperate with a microprocessor in order to perform one of the methods described herein. Generally, the methods are performed by any hardware apparatus.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

1. A radio transmitter apparatus for transmitting a data transmission for at least one radio tag of a plurality of radio tags, wherein
the data transmission comprises a first part and a second part including data to be transmitted to the at least one radio tag, and
the radio transmitter apparatus is to process the second part of the data transmission such that the data is free of a pattern representing a start indicator for any of the plurality of radio tags.

2. The radio transmitter apparatus of claim 1, wherein the first part includes a start indicator, e.g., start indicator of the at least one radio tag.

3. The radio transmitter apparatus of claim 1, wherein the first part contains control signaling associated with the second part of the data transmission.

4. The radio transmitter apparatus of claim 1, wherein the start indicator causes one or more radio tags, or a group of radio tags to be activated for a communication.

5. The radio transmitter apparatus of claim 4, wherein the at least one radio tag is an Ambient IoT (A-IoT) device, and wherein the data transmission comprises an A-IoT Reader-to-Device (R2D) signal divided into two parts, the first part including an R2D Timing Acquisition Signal (R-TAS), which includes a Start Indication Pattern (SIP) and a Clock Acquisition Part (CAP), and the second part including a physical reader-to-device channel (PRDCH) and a postamble.

6. The radio transmitter apparatus of claim 5, wherein the SIP provides a recognizable sequence that enables the A-IoT device to differentiate the A-IoT Reader-to-Device (R2D) signal from noise or other transmissions, and wherein the CAP provides additional control signaling and clock synchronization for an accurate decoding of the subsequent PRDCH.

7. The radio transmitter apparatus of claim 5, wherein the CAP of the R-TAS encodes a chip rate of a remainder of the transmission, e.g., a number of chips per OFDM symbol
$$( {M}_{c h i p}^{s y m b} ) ,$$

8. The radio transmitter apparatus of claim 7, wherein a value of
$${M}_{c h i p}^{s y m b}$$
according to which the CAP is received is determined from among those given in the following table:

| Number of chips per OFDM | |
|---|---|
| $symbol ( {M}_{chip}^{symb} )$ | ${N}_{R B}^{min}$ |
| 2 | 1 |
| 6 | 1 |
| 12 | 2 |
| 24 | 3 |

9. The radio transmitter apparatus of claim 5, wherein a PRDCH transmission begins in chip
$$χ = {χ}_{s t a r t}^{P R D C H} ,$$
where:
$${χ}_{s t a r t}^{P R D C H} = {N}_{SIP} + {N}_{CAP} ,$$
and
an R2D transport block size is
$${N}_{T B S}^{R 2 D} .$$

10. The radio transmitter apparatus of claim 1,
wherein the start indicator comprises one or more of the following:
a preamble,
one or more pilot symbols, e.g., a configured or preconfigured pattern of symbols,
a Zadoff-Chu sequence, and
wherein the start indicator comprises the start indicator part (SIP) of the R2D timing acquisition signal (R-TAS) which consists of N_{SIP}=8 bits denoted S₀, S₁, S₂, S₃, S₄, S₅, S₆, S₇=1, 1, 0, 0, 1, 0, 0, 0.

11. The radio transmitter apparatus of claim 1, wherein the radio transmitter apparatus is to process the second part of the data transmission before transmitting the data transmission for the at least one radio tag using one or more of the following:
data scrambling,
data interleaving,
bit insertion,
bit extraction or deletion,
Cyclic Redundancy Check, CRC, adaption.

12. The radio transmitter apparatus of claim 11, wherein the radio transmitter apparatus is to insert one or more bits or chips at one or more certain positions in the second part of the data transmission, e.g., such that any start indicator pattern in the data is interrupted.

13. The radio transmitter apparatus of claim 11, wherein
the radio transmitter apparatus processes the second part of the A-IoT Reader-to-Device (R2D) signal using padding chips that are set to any values which do not result in another R-TAS SIP.

14. The radio transmitter apparatus of claim 13, wherein, for an R2D transmission the mapping to chips is as follows:
to chips χ=0 and up are mapped:
the bits of the R-TAS SIP in sequence starting with S₀ followed by
the bits of the R-TAS CAP in sequence starting with A₀ followed by
the bits of PRDCH in sequence starting with c₀ followed by
the bits of the R2D postamble in sequence starting with P₀.

15. The radio transmitter apparatus of claim 14, wherein, if
$${M}_{c h i p}^{s y m b} = 24 ,$$
chips χ=χ′, χ′+1 satisfying (χ′−N_{SIP}) modulo
$${M}_{c h i p}^{s y m b} = {M}_{c h i p}^{s y m b} - 2$$
are skipped for the mapping of PRDCH and the R2D postamble, and are instead set to values of 1.

16. The radio transmitter apparatus of claim 15, wherein, following postamble bit P₃, the smallest integer N_{pad}≥0 padding chips are inserted, if needed, until
$$( {M}_{c h i p}^{R 2 D} - {N}_{SIP} )$$
modulo
$${M}_{c h i p}^{s y m b} = 0 ,$$
with the padding chips set to any values which do not result in another R-TAS SIP, and wherein, if
$${M}_{c h i p}^{s y m b} = 24 ,$$
values of 1 are mapped to the final two padding chips.

17. A radio tag for receiving from a radio transmitter apparatus, which serves a plurality of radio tags, a data transmission, wherein
the data transmission comprises a first part and a second part including data to be transmitted to the at least one radio tag, and
the radio tag is to process the second part of the data transmission received from the radio transmitter apparatus for acquiring from the received data transmission payload data and/or control data for the radio tag.

18. The radio tag of claim 17, wherein
the at least one radio tag is an Ambient IoT (A-IoT) device,
the data transmission comprises an A-IoT Reader-to-Device (R2D) signal divided into two parts, the first part including an R2D Timing Acquisition Signal (R-TAS), which includes a Start Indication Pattern (SIP) and a Clock Acquisition Part (CAP), and the second part including a physical reader-to-device channel (PRDCH) and a postamble.
the CAP of the R-TAS encodes a chip rate of a remainder of the transmission, e.g., a number of chips per OFDM symbol
$$( {M}_{c h i p}^{s y m b} ) ,$$
the value of
$${M}_{c h i p}^{s y m b}$$
according to which the CAP is received being determined from among those given in the following table:

| Number of chips per OFDM | |
|---|---|
| $symbol ( {M}_{chip}^{symb} )$ | ${N}_{R B}^{min}$ |
| 2 | 1 |
| 6 | 1 |
| 12 | 2 |
| 24 | 3 |

a PRDCH transmission begins in chip
$$χ = {χ}_{s t a r t}^{P R D C H} ,$$
where:
$${χ}_{s t a r t}^{P R D C H} = {N}_{SIP} + {N}_{CAP} ,$$
and
an R2D transport block size is
$${N}_{T B S}^{R 2 D} .$$

19. The radio tag of claim 17, wherein
the second part of the A-IoT Reader-to-Device (R2D) signal comprises padding chips that are set to any values which do not result in another R-TAS SIP,
the mapping to chips is as follows:
to chips χ=0 and up are mapped:
the bits of the R-TAS SIP in sequence starting with S₀ followed by
the bits of the R-TAS CAP in sequence starting with A₀ followed by
the bits of PRDCH in sequence starting with c₀ followed by
the bits of the R2D postamble in sequence starting with P₀,
if
$${M}_{c h i p}^{s y m b} = 24 ,$$
chips χ=χ′, χ′+1 satisfying (χ′−N_{SIP}) modulo
$${M}_{c h i p}^{s y m b} = {M}_{c h i p}^{s y m b} - 2$$
skipped for the mapping of PRDCH and the R2D postamble, and are instead set to values of 1, and
following postamble bit P₃, the smallest integer N_{pad}≥0 padding chips are inserted, if needed, until
$$( {M}_{c h i p}^{R 2 D} - {N}_{SIP} )$$
modulo
$${M}_{c h i p}^{s y m b} = 0 ,$$
with the padding chips set to any values which do not result in another R-TAS SIP, and wherein, if
$${M}_{c h i p}^{s y m b} = 24 ,$$
values of 1 are mapped to the final two padding chips.

20. A method for operating a radio transmitter apparatus for transmitting a data transmission for at least one radio tag of a plurality of radio tags, wherein the data transmission comprises a first part and a second part including data to be transmitted to the at least one radio tag, the method comprising:
processing the second part of the data transmission such that the data is free of a pattern representing a start indicator for any of the plurality of radio tags.
